(19) United States
(12) Patent Application Publication
(10) Pub. No.: US 2026/0296372 A1
(43) Pub. Date: Oct. 1, 2026

(54) VEHICLE AUTHENTICATION SYSTEM

(71) Applicant: HONDA MOTOR CO., LTD., Tokyo (JP)

(72) Inventors: Naoto Yamamoto, Tokyo (JP); Seonghun Lee, Tokyo (JP)

(21) Appl. No.: 19/576,659

(22) Filed: Mar. 24, 2026

(30) Foreign Application Priority Data
Mar. 28, 2025 (JP) 2025-056807

(51) Int. Cl. B60R 25/31; B60R 25/30; G06V 20/58; G06V 40/10

(52) U.S. Cl. CPC B60R 25/31; B60R 25/305; G06V 20/58; G06V 40/10

(57) ABSTRACT

A vehicle authentication system includes: a detection section that detects an object approaching a mobile body and, after detecting the object, detects a target person approaching the mobile body; and an authentication section that performs authentication of the target person as a registered user, in which after detecting the object by an object detection sensor provided in the mobile body, the detection section is capable of executing detection of the target person by a camera provided in the mobile body and detection of the target person by the object detection sensor.

### INCORPORATION BY REFERENCE

The present application claims priority under 35 U.S.C. §119 to Japanese Patent Application No. 2025-056807 filed on Mar. 28, 2025. The content of the application is incorporated herein by reference in its entirety.

### BACKGROUND OF THE INVENTION

### Field of the Invention

The present invention relates to a vehicle authentication system.

### Description of the Related Art

Conventionally, a technique has been known that performs authentication processing of a registered user based on a photographed image taken by a camera. For example, Japanese Patent No. 7193453 discloses a vehicle monitoring system in which upon detection of a moving body by an infrared sensor, a camera is started and authentication processing of a registered user is performed based on a photographed image taken by the camera.

However, a photographed image taken by a camera could have blown-out highlights or crushed shadows depending on the surrounding environment of a vehicle or be affected by bad weather due to fog, rain, or the like. In such cases, there is a problem in that depending on the surrounding environment of a vehicle, authentication of a registered user using a photographed image taken by a camera cannot be performed.

In order to solve the aforementioned problems, the present application has an object of enabling authentication of a registered user without being affected by the surrounding environment.

### SUMMARY OF THE INVENTION

One aspect for achieving the aforementioned object is a vehicle authentication system including: a detection section that detects an object approaching a mobile body and, after detecting the object, detects a target person approaching the mobile body; and an authentication section that performs authentication of the target person as a registered user, in which after detecting the object by an object detection sensor provided in the mobile body, the detection section is capable of executing detection of the target person by a camera provided in the mobile body and detection of the target person by the object detection sensor.

According to the aspect of the present invention, authentication of a registered user is enabled without being affected by the surrounding environment.

### BRIEF DESCRIPTION OF THE DRAWINGS

FIG. 1 is a view showing the configuration of a vehicle in Embodiment 1;

FIG. 2 is a view showing the configuration of a vehicle authentication system in Embodiment 1;

FIG. 3 is a flowchart showing an operation of vehicle authentication processing in a vehicle authentication device in Embodiment 1;

FIG. 4 is a flowchart showing an operation of first detection processing in the vehicle authentication device in Embodiment 1;

FIG. 5 is a flowchart showing an operation of the first detection processing in the vehicle authentication device in Embodiment 1;

FIG. 6 is a flowchart showing an operation of the first detection processing in the vehicle authentication device in Embodiment 1;

FIG. 7 is a flowchart showing an operation of second detection processing in the vehicle authentication device in Embodiment 1; and

FIG. 8 is a flowchart showing an operation of the first detection processing in the vehicle authentication device in Embodiment 2.

### DETAILED DESCRIPTION OF THE INVENTION

Hereinafter, embodiments of the present invention will be described with reference to the drawings.

### 1. Embodiment 1

### [1-1. Configuration of Vehicle]

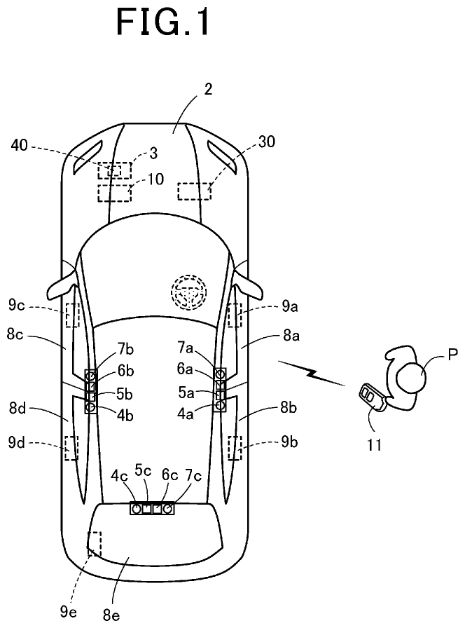

FIG. 1 is a view showing the configuration of a mobile body 2 in which a vehicle authentication system 1 of the present embodiment is mounted. The mobile body 2 includes a vehicle authentication device 3 and an image authentication ECU (Electronic Control Unit) 30 that constitute the vehicle authentication system 1. The vehicle authentication system 1 is mounted on the mobile body 2, and authenticates a target person P who is any person trying to make an entry to the mobile body 2 and allows the target person P to use the mobile body 2 when the target person P can be authenticated as a person who has an authorized usage right of the mobile body 2. Here, the “entry” to the mobile body 2 refers to boarding (or embarking on) the mobile body 2 at least from the outside of the mobile body 2, and may additionally include starting the use of the system by, for example, logging into the system of the mobile body 2 after boarding.

In the present embodiment, the mobile body 2 is, for example, a passenger car and may be a shared car in which a plurality of persons can be on board. However, the mobile body 2 may be any mobile body without being limited to a passenger car. Such mobile bodies may include land mobile bodies such as a passenger car, a bus, a taxi, and a train, and in addition, marine mobile bodies such as a vessel and a submarine and aerial mobile bodies such as an aircraft including an eVTOL (Electric Vertical Take-Off and Landing aircraft) and an airship.

The right side part of the mobile body 2 is provided with a right ranging sensor 4a that detects an object present on the right side of the mobile body 2, a first right camera 5a and a second right camera 6a that photograph the right side of the mobile body 2, and a right illuminator 7a that illuminates the right side of the mobile body 2.

The left side part of the mobile body 2 is provided with a left ranging sensor 4b that detects an object present on the left side of the mobile body 2, a first left camera 5b and a second left camera 6b that photograph the left side of the mobile body 2, and a left illuminator 7b that illuminates the left side of the mobile body 2.

The rear part of the mobile body 2 is provided with a rear ranging sensor 4c that detects an object present on the rear side of the mobile body 2, a first rear camera 5c and a second rear camera 6c that photograph the rear side of the mobile body 2, and a rear illuminator 7c that illuminates the rear side of the mobile body 2.

Hereinafter, the right ranging sensor 4a, the left ranging sensor 4b, and the rear ranging sensor 4c are represented as a ranging sensor 4 when not distinguished from one another. Further, the first right camera 5a, the first left camera 5b, and the first rear camera 5c are represented as a first camera 5 when not distinguished from one another. Furthermore, the second right camera 6a, the second left camera 6b, and the second rear camera 6c are represented as a second camera 6 when not distinguished from one another. Also, the right illuminator 7a, the left illuminator 7b, and the rear illuminator 7c are represented as an illuminator 7 when not distinguished from one another.

The second camera 6 has a higher resolution and a higher power consumption as compared to the first camera 5.

The first camera 5 and the second camera 6 are, for example, CCD cameras having different pixel counts.

A photographed image taken by the first camera 5 could have blown-out highlights or crushed shadows depending on the surrounding environment of the mobile body 2 or could be affected by bad weather due to fog, rain, or the like. Meanwhile, a photographed image taken by the second camera 6 is less susceptible to the surrounding environment of the mobile body 2 than a photographed image taken by the first camera 5. This results from the difference in resolution between the first camera 5 and the second camera 6, the presence or absence of illumination by the illuminator 7, and the difference in photographing target range between the first camera 5 and the second camera 6. For example, the second camera 6 has a higher resolution than the first camera 5, and the illuminator 7, turned off while the first camera 5 is photographing, is turned on while the second camera 6 is photographing. Further, a photographing range (range in accordance with the usage of the photographed image taken by the first camera 5) of the first camera 5 is a range of around 0.8 m to 5 m from the mobile body 2. Meanwhile, a photographing range (range in accordance with the usage of the photographed image taken by the second camera 6) of the second camera 6 is a range of around 0 m to 0.8 m from the mobile body 2.

The ranging sensor 4 is, for example, any sensor that can detect an object in the surroundings to measure the distance to the object. In the present embodiment, the ranging sensor 4 is a radar, more specifically, a millimeter wave radar. The ranging sensor 4 may be, for example, a LiDar, or a sonar as well as a radar.

The illuminator 7 illuminates the photographing range by the second camera 6. The illuminator 7 may be configured using, for example, any light emitter or light-emitting element. In the present embodiment, the illuminator 7 is, for example, an LED floodlight.

The mobile body 2 also includes a door opening-closing device 9 that is provided in each of doors 8 of the mobile body 2 and that locks/unlocks the door 8 and opens/closes the door 8. The door opening-closing device 9 may include an actuator that locks/unlocks the corresponding door 8 and an actuator that opens/closes the door 8.

In the present embodiment, the mobile body 2 includes, as the door 8 and the door opening-closing device 9, a front right side door opening-closing device 9a provided in a driver's door 8a on the front right side of the mobile body 2 and a rear right side door opening-closing device 9b provided in a rear right door 8b on the rear right side of the mobile body 2. Further, the mobile body 2 includes a front left side door opening-closing device 9c provided in a passenger's door 8c on the front left side of the mobile body 2 and a rear left side door opening-closing device 9d provided in a rear left door 8d on the rear left side of the mobile body 2. The mobile body 2 further includes a rear gate opening-closing device 9e provided in a rear gate (tailgate) 8e of the mobile body 2.

The mobile body 2 also includes a communication device 10. The communication device 10 includes a transmitter and receiver for communicating with an electronic key 11 used for the use of the mobile body 2. The electronic key 11 may be, for example, a smart key such as an FOB key or a mobile terminal such as a smartphone in which key information used for the use of the mobile body 2 is stored.

The mobile body 2 also includes a temperature sensor 40. The temperature sensor 40 is a sensor that is provided in the vehicle authentication device 3 and that can detect the temperature of the vehicle authentication device 3.

In general, as the processing load of a processor increases, the temperature of the processor increases, thereby occasionally decreasing the processing speed of the processor with the temperature increased. Therefore, in the present embodiment, the temperature of the vehicle authentication device 3 (a first processor 20, in particular) detected by the temperature sensor 40 is used as an indicator of the processing speed of the first processor 20.

### [1-2. Configuration of Vehicle Authentication System]

The configuration of the vehicle authentication system 1 will be described.

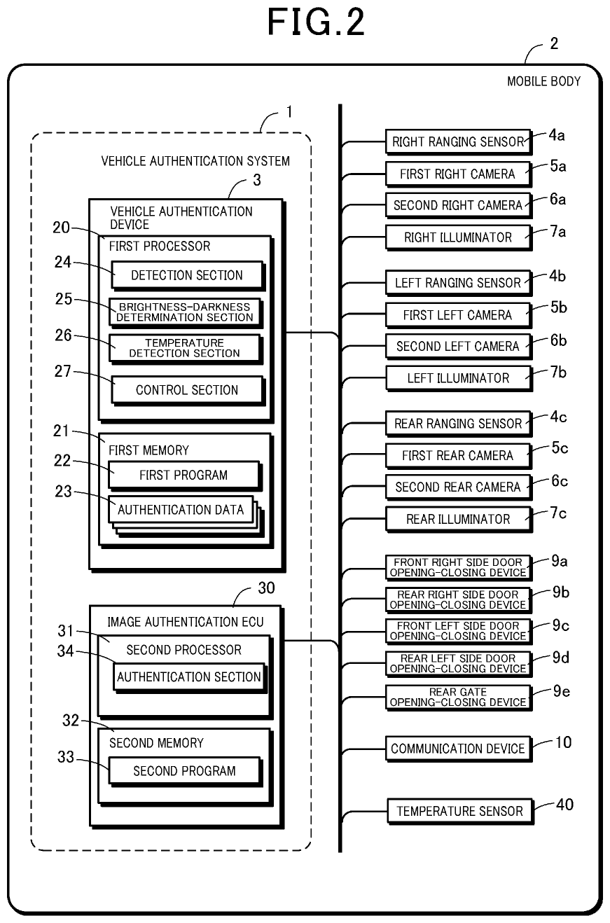

FIG. 2 is a view showing the configuration of the vehicle authentication system 1. The vehicle authentication system 1 includes at least the vehicle authentication device 3 and an image authentication ECU 30. The vehicle authentication system 1 authenticates the target person P who is any person trying to make an entry to the mobile body 2 and allows the target person P to use the mobile body 2 when the target person P can be authenticated. The aforementioned authentication is performed based on a facial image acquired of the target person P.

Note that hereafter, the “target person” refers to a person as a target of authentication by the vehicle authentication system 1. The “user” refers to a registered user who is registered in advance as a person who has an authorized right for the use of the mobile body 2 and a person who actually uses the mobile body 2. The target person P becomes a user when authenticated by the vehicle authentication system 1 to become eligible for the use of the mobile body 2.

Part of functional elements of the vehicle authentication device 3 shown below may be included in another device. For example, a control section 27 (described later) included in the vehicle authentication device 3 may be implemented as a functional element of the electronic control unit (ECU) that controls the operation of the mobile body 2. In this case, the vehicle authentication system 1 includes the vehicle authentication device 3 and the aforementioned electronic control unit, and the vehicle authentication device 3, through communication with the aforementioned electronic control unit, can cause the electronic control unit to execute the function of the control section 27.

The vehicle authentication system 1 may also include other equipment such as the ranging sensor 4, the first camera 5, the second camera 6, and the temperature sensor 40 that are used by the vehicle authentication device 3.

Further, the functional element of the image authentication ECU 30 shown below may be included in another device. For example, an authentication section 34 (described later) included in the image authentication ECU 30 may be implemented as a functional element of the vehicle authentication device 3. In this case, the vehicle authentication system 1 may include only the vehicle authentication device 3.

The vehicle authentication device 3 includes the first processor 20 and a first memory 21. The first memory 21 is configured with, for example, a volatile and/or nonvolatile semiconductor memory and/or a hard disk device. The first memory 21 stores authentication data 23 of one or each of a plurality of registered users registered in advance as a person who has an authorized right for the use of the mobile body 2.

The first processor 20 is, for example, a computer including a CPU (Central Processing Unit) and the like. The first processor 20 may be configured with a ROM (Read Only Memory) in which programs are written, a RAM (Random Access Memory) for temporarily storing data, and the like. Further, the first processor 20 includes, as functional elements or functional units, a detection section 24, a brightness-darkness determination section 25, a temperature detection section 26, and the control section 27.

These functional elements included in the first processor 20 are implemented by, for example, the first processor 20 as a computer executing a first program 22 stored in the first memory 21. Note that the first program 22 may be stored in any computer-readable storage medium. Alternatively, all or part of the aforementioned functional elements included in the first processor 20 may also be configured with pieces of hardware each including one or more electronic circuit components.

The image authentication ECU 30 includes a second processor 31 and a second memory 32. The second memory 32 is configured with, for example, a volatile and/or nonvolatile semiconductor memory and/or a hard disk device.

The second processor 31 is, for example, a computer including a CPU (Central Processing Unit) and the like. The second processor 31 may be configured with a ROM (Read Only Memory) in which programs are written, a RAM (Random Access Memory) for temporarily storing data, and the like. Further, the second processor 31 includes, as a functional element or a functional unit, the authentication section 34.

The aforementioned functional element included in the second processor 31 is implemented by, for example, the second processor 31 as a computer executing a second program 33 stored in the second memory 32. Note that the second program 33 may be stored in any computer-readable storage medium. Alternatively, all or part of the aforementioned functional element included in the second processor 31 may be configured with pieces of hardware each including one or more electronic circuit components.

Hereinafter, the functional elements included in the first processor 20 of the vehicle authentication device 3 and the functional element included in the second processor 31 of the image authentication ECU 30 will be described.

The detection section 24 detects an object approaching the mobile body 2 and after detecting the object, detects the target person P approaching the mobile body 2. After detecting the object by the ranging sensor 4 provided in the mobile body 2, the detection section 24 can execute the detection of the target person P by the first camera 5 provided in the mobile body 2 and the detection of the target person P by the ranging sensor 4.

The “detection of the target person P” is a concept including detection that the detected object is the target person P and detection of the presence or absence of an intention of boarding the mobile body 2 by the detected target person P.

Specifically, the detection section 24 determines, using the ranging sensor 4, whether an entity (or an object) has entered a range of a preset predetermined distance from the mobile body 2. The entity may be any object, including living and non-living objects.

Further, when an object is detected by the ranging sensor 4, the detection section 24 can execute person-detection processing and boarding-intention-determination processing using the ranging sensor 4 and the first camera 5 near the ranging sensor 4 that detects the object. The person-detection processing is processing of detecting that the detected object is the target person P. The boarding-intention-determination processing is processing of assuming that the detected object is the target person P and determining the presence or absence of an intention of boarding the mobile body 2 by the target person P.

The detection section 24 performs the following processing, as the person-detection processing using the first camera 5. The detection section 24 performs image recognition processing of a photographed image acquired from the first camera 5 and determines whether the object is a person and identifies a moving direction of the person. Then, the detection section 24 can recognize at a preset frequency that the aforementioned object is a person, and when the object recognized as a person is determined to be moving in a direction approaching the mobile body 2, determines that the object is the target person P. Hereinafter, the person-detection processing using the first camera 5 is occasionally referred to as camera-using person-detection processing.

Further, the detection section 24 performs the following processing, as the person-detection processing using the ranging sensor 4. The detection section 24 repeatedly acquires, using the ranging sensor 4, the distance from the mobile body 2 to an object at a preset predetermined time interval. Then, when the moving speed of the object is within a preset predetermined range and the distance between the object and the mobile body 2 decreases over time based on the distance acquired at the predetermined time interval, the detection section 24 determines that the object is the target person P. Hereinafter, the person-detection processing using the ranging sensor 4 is occasionally referred to as sensor-using person-detection processing.

Furthermore, the detection section 24 performs the following processing, as the boarding-intention-determination processing using the first camera 5. The detection section 24 performs the image recognition processing of the photographed image acquired from the first camera 5, and when the target person P moves in a direction approaching the mobile body 2 and the target person P stops within a range of a preset predetermined distance from the door of the mobile body 2, determines that the target person P has an intention of boarding the mobile body 2. Hereinafter, the boarding-intention-determination processing using the first camera 5 is occasionally referred to as camera-using boarding-intention-determination processing.

In addition, the detection section 24 performs the following processing, as the boarding-intention-determination processing using the ranging sensor 4. The detection section 24 determines the presence or absence of an intention of boarding the mobile body 2 by the target person P in accordance with whether the target person P stops within a range of a preset predetermined distance from the door of the mobile body 2, based on a temporal change in the distance from the mobile body 2 to the target person P, the distance being acquired from the ranging sensor 4. For example, when the target person P stops within a range of a preset predetermined distance from the door of the mobile body 2, the detection section 24 determines that the target person P has an intention of boarding the mobile body 2. Hereinafter, the boarding-intention-determination processing using the ranging sensor 4 is occasionally referred to as sensor-using boarding-intention-determination processing.

In this manner, the detection section 24 detects the presence or absence of a boarding intention of the target person P in accordance with whether the target person P stops within a predetermined distance from the mobile body 2, based on a temporal change in the distance from the mobile body 2 to the target person P, the distance being acquired from the ranging sensor 4.

Further, after detecting the object by the ranging sensor 4 provided in the mobile body 2, the detection section 24 can concurrently execute the detection of the target person P by the first camera 5 provided in the mobile body 2 and the detection of the target person P by the ranging sensor 4.

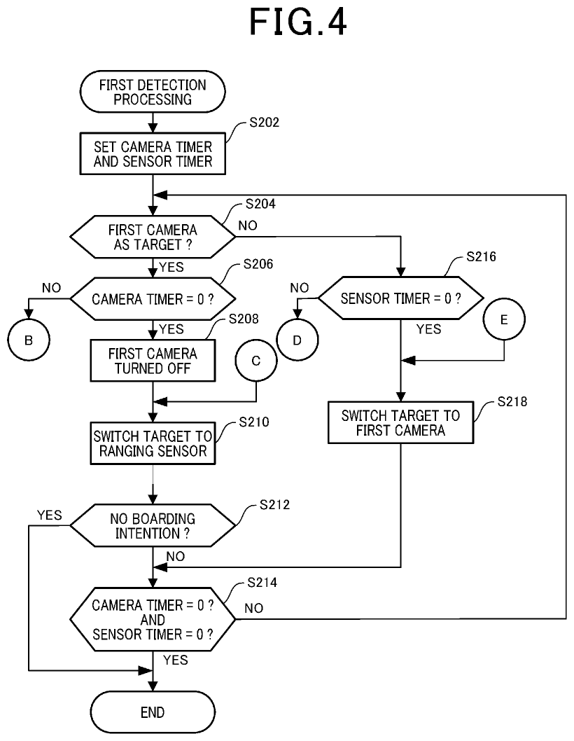

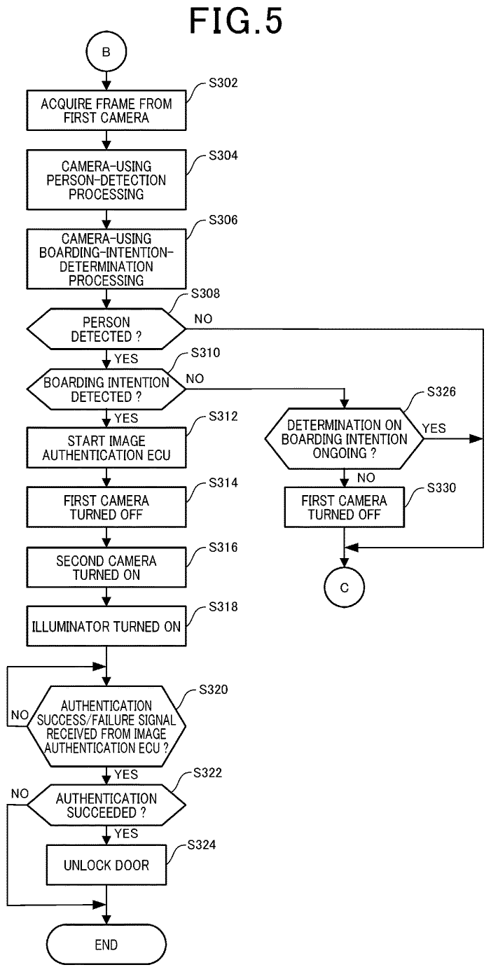

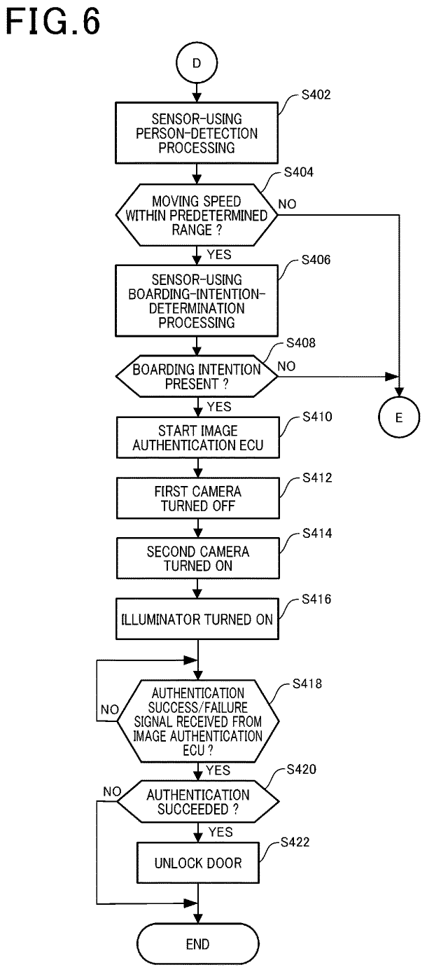

Specifically, the detection section 24 repeatedly performs the processing on the detection of the target person P by the ranging sensor 4 and the processing on the detection of the target person P by the first camera 5 over a short period of time for each piece of processing to be able to concurrently execute the pieces of processing. The details will be described later using FIG. 4 to FIG. 6.

The authentication section 34 authenticates the target person P as a registered user.

Specifically, the authentication section 34 authenticates the target person P as a registered user based on a facial image of the target person P. The authentication of the target person P based on the facial image in the authentication section 34 may be performed as follows, for example.

Specifically, when the detection section 24 detects the target person P, the authentication section 34 acquires a high-definition image of the target person P from the second camera 6 that is close to the first camera 5 used for the detection of the target person P. Then, the authentication section 34 performs the authentication of the target person P based on the acquired facial image of the target person P.

The authentication section 34 calculates the feature amounts of the acquired facial image and calculates, for each registered user, matching scores indicating the degree of matching between the calculated feature amounts (hereinafter, target feature amounts) and the feature amounts (hereinafter, feature amounts for authentication) of a facial image stored in the authentication data 23 of each registered user stored in the first memory 21.

Then, the authentication section 34 determines whether the target person P is any registered user, based on the aforementioned calculated matching scores. Specifically, for example, when there are matching scores that are equal to or greater than a predetermined value in the aforementioned calculated matching scores, the authentication section 34 authenticates the target person P as a registered user corresponding to the matching score indicating the highest value among the matching scores that are equal to or greater than the predetermined value. Thus, the authentication of the target person P succeeds.

Meanwhile, when there is no matching score that is equal to or greater than the predetermined value in the aforementioned calculated matching scores, the authentication section 34 determines that the target person P is not a registered user. Thus, the authentication of the target person P fails.

The authentication section 34 starts the authentication in response to the target person P having been detected by the detection section 24.

Specifically, the image authentication ECU 30 including the authentication section 34 is started when the detection section 24 determines that the target person P has an intention of boarding the mobile body 2. The authentication section 34 starts the authentication of the registered user, upon starting the image authentication ECU 30.

The authentication section 34 starts the authentication based on completion of the detection of the target person P by one of the first camera 5 and the ranging sensor 4 that is earlier than the detection of the target person P by the other.

Specifically, the image authentication ECU 30 including the authentication section 34 is triggered to be started by concurrent execution of the detection of the target person P by the first camera 5 provided in the mobile body 2 and the detection of the target person P by the ranging sensor 4 and completion of one of the detections. Then, the authentication section 34 starts the authentication of the registered user, upon starting the start of the image authentication ECU 30.

The brightness-darkness determination section 25 determines whether the surrounding environment of the first camera 5 is in a bright state or a dark state, after detecting the object by the ranging sensor 4. The bright state is a concept including a first bright state and a second bright state that are described below.

For example, the brightness-darkness determination section 25 determines the illuminance in the surroundings of the first camera 5 based on a photographed image taken by the first camera 5. Specifically, the brightness-darkness determination section 25 determines the dark state when the illuminance is less than a first threshold, determines the first bright state when the illuminance is equal to or greater than the first threshold and less than a second threshold, and determines the second bright state when the illuminance is equal to or greater than the second threshold. The first bright state is a state having a moderate brightness to such a degree in which the first camera 5 is expected to normally operate (the detection of the target person P using a photographed image taken by the first camera 5 is available), and the second bright state is an excessively bright state to such a degree in which a photographed image taken by the first camera 5 is expected to possibly have blown-out highlights.

In the present embodiment, as the first threshold, a first outdoor threshold assuming a case in which the mobile body 2 is located outdoors and a first indoor threshold assuming a case in which the mobile body 2 is located indoors are provided. Further, as the second threshold, a second outdoor threshold assuming a case in which the mobile body 2 is located outdoors and a second indoor threshold assuming a case in which the mobile body 2 is located indoors are provided.

The detection section 24 can select and execute one or both of the detection of the target person P by the first camera 5 and the detection of the target person P by the ranging sensor 4, based on the determination result of the brightness-darkness determination section 25.

For example, the detection section 24 can concurrently execute the detection of the target person P by the first camera 5 and the detection of the target person P by the ranging sensor 4 when the bright state is determined by the brightness-darkness determination section 25.

Further, for example, when the dark state or the second bright state is determined by the brightness-darkness determination section 25, the detection section 24 executes the detection of the target person P by the ranging sensor 4 without performing the detection of the target person P by the first camera 5.

The temperature detection section 26 detects the temperature of a member having the function of the detection section 24. In the present embodiment, the member having the function of the detection section 24 is the vehicle authentication device 3. Specifically, the temperature detection section 26 detects the temperature of the vehicle authentication device 3 using the temperature sensor 40.

After detecting an object by the ranging sensor 4, the detection section 24 can select and execute one or both of the detection of the target person P by the first camera 5 and the detection of the target person P by the ranging sensor 4, based on the temperature detected by the temperature detection section 26.

For example, when the temperature detected by the temperature detection section 26 is less than a predetermined value, the detection section 24 concurrently executes the detection of the target person P by the first camera 5 and the detection of the target person P by the ranging sensor 4.

Further, for example, when the temperature detected by the temperature detection section 26 is equal to or greater than a predetermined value, the detection section 24 selects and executes the detection of the target person P by the ranging sensor 4 without performing the detection of the target person P by the first camera 5.

The control section 27 controls the operation of the mobile body 2.

When the authentication of the target person P by the authentication section 34 succeeds, the control section 27 instructs the door opening-closing device 9 of the mobile body 2 to automatically unlock the door 8. In doing so, the control section 27 may instruct the door opening-closing device 9 to automatically open the door 8 after instructing the door opening-closing device 9 to unlock the door 8. The control section 27 can execute the automatic unlocking and opening operations targeting the door 8 closest to the target person P, for example. The door 8 closest to the target person P may be specified, for example, by the control section 27 from the latest photographed image taken by the second camera 6.

### [1-3. Operation of Vehicle Authentication Device]

Next, the operation of the vehicle authentication device 3 according to the present embodiment will be described.

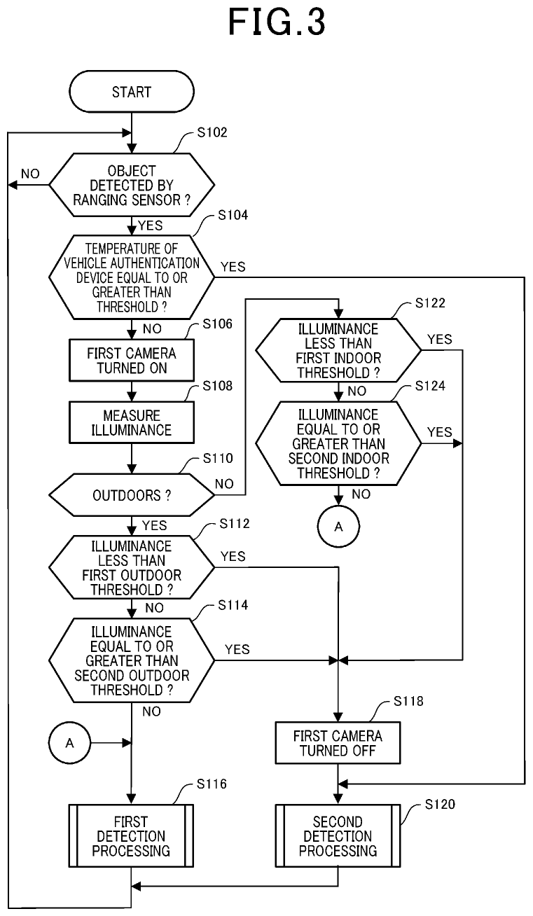

FIG. 3 is a flowchart showing the operation of the vehicle authentication processing in the vehicle authentication device 3. The vehicle authentication processing is processing performed by the first processor 20 of the vehicle authentication device 3.

The detection section 24 determines, using the ranging sensor 4, whether an object has been detected within a range of a predetermined distance from the mobile body 2 (step S102). When no object is detected, the detection section 24 returns to step S102 and repeats the processing, and waits for an object being detected.

Meanwhile, when an object has been detected within a range of a predetermined distance from the mobile body 2, the first processor 20 determines whether the temperature of the vehicle authentication device 3 is equal to or greater than a predetermined value (step S104). The temperature of the vehicle authentication device 3 is acquired from the temperature sensor 40. When the temperature of the vehicle authentication device 3 is equal to or greater than the predetermined value, the first processor 20 proceeds to step S120.

When the temperature of the vehicle authentication device 3 is less than a predetermined value, the first processor 20 turns on the first camera 5 that is close to the ranging sensor 4 used for the detection of the object (step S106). Then, the brightness-darkness determination section 25 measures the illuminance in the surroundings of the mobile body 2 using the first camera 5 (step S108).

The first processor 20 determines whether the mobile body 2 is located outdoors (step S110). For example, the first processor 20 acquires the current position of the mobile body 2 and map information from a navigation device (not shown) to determine whether the mobile body 2 is located outdoors.

When the mobile body 2 is located outdoors, the brightness-darkness determination section 25 determines whether the illuminance is less than the first outdoor threshold (step S112). When the illuminance is not less than the first outdoor threshold, the brightness-darkness determination section 25 determines whether the illuminance is equal to or greater than the second outdoor threshold (step S114).

When the illuminance is neither less than the first outdoor threshold nor equal to or greater than the second outdoor threshold, that is, the mobile body 2 is located in a moderately bright place outdoors (when the surrounding environment of the mobile body 2 is in the first bright state), the first processor 20 performs first detection processing (step S116). The first detection processing is processing of performing detection of a target person and determination on the presence or absence of a boarding intention of the target person, using the ranging sensor 4 and the first camera 5. The details of the first detection processing will be described later in FIG. 4 to FIG. 6.

In this manner, the vehicle authentication system 1 is configured such that when the mobile body 2 is located in a moderately bright place outdoors, the detection of a target person and determination on the presence or absence of a boarding intention of the target person are performed using the ranging sensor 4 and the first camera 5.

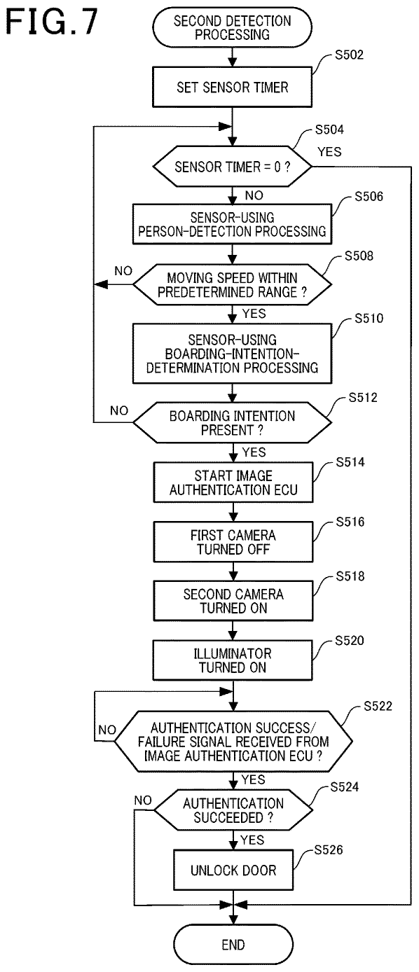

In step S112, when the illuminance is less than the first outdoor threshold, that is, the mobile body 2 is located in a dark place outdoors (when the surrounding environment of the mobile body 2 is in the dark state), the first processor 20 turns off the first camera 5 (step S118) and performs second detection processing (step S120). The second detection processing is processing of performing detection of a target person and determination on the presence or absence of a boarding intention of the target person, using the ranging sensor 4. In the second detection processing, the detection of a target person and determination on the presence or absence of a boarding intention of the target person using the first camera 5 are not performed. The details of the second detection processing will be described later in FIG. 7.

Further, in step S114, when the illuminance is equal to or greater than the second outdoor threshold, that is, the mobile body 2 is located in an excessively bright place outdoors (when the surrounding environment of the mobile body 2 is in the second bright state), the first processor 20 proceeds to step S118.

In this manner, the vehicle authentication system 1 is configured such that when the mobile body 2 is located in a dark place or an excessively bright place outdoors, the detection of a target person and determination on the presence or absence of a boarding intention of the target person are performed using only the ranging sensor 4.

When the mobile body 2 is located indoors, the brightness-darkness determination section 25 determines whether the illuminance is less than the first indoor threshold (step S122). When the illuminance is not less than the first indoor threshold, the brightness-darkness determination section 25 determines whether the illuminance is equal to or greater than the second indoor threshold (step S124).

When the illuminance is neither less than the first indoor threshold nor equal to or greater than the second indoor threshold, that is, the mobile body 2 is located in a moderately bright place indoors (when the surrounding environment of the mobile body 2 is in the first bright state), the first processor 20 proceeds to step S116.

In this manner, the vehicle authentication system 1 is configured such that when the mobile body 2 is located in a moderately bright place indoors, the detection of a target person and determination on the presence or absence of a boarding intention of the target person are performed using the ranging sensor 4 and the first camera 5.

In step S122, when the illuminance is less than the first indoor threshold, that is, the mobile body 2 is located in a dark place indoors (when the surrounding environment of the mobile body 2 is in the dark state), the first processor 20 proceeds to step S118. Further, in step S124, when the illuminance is equal to or greater than the second indoor threshold, that is, the mobile body 2 is located in an excessively bright place indoors (when the surrounding environment of the mobile body 2 is in the second bright state), the first processor 20 proceeds to step S118.

In this manner, the vehicle authentication system 1 is configured such that when the mobile body 2 is located in a dark place or an excessively bright place indoors, the detection of a target person and determination on the presence or absence of a boarding intention of the target person are performed using only the ranging sensor 4.

After performing the processing of step S116 or step S120, the first processor 20 proceeds to step S102.

Note that the processing of step S102 is executed by the detection section 24.

The processing of steps S108 to S114, S122, and S124 is performed by the brightness-darkness determination section 25.

The processing of step S104 is executed by the temperature detection section 26.

FIG. 4 to FIG. 6 are flowcharts showing the operations of the first detection processing in the vehicle authentication device 3. The first detection processing is processing performed by the first processor 20 of the vehicle authentication device 3.

The first processor 20 sets predetermined values for a camera timer for measuring an operation time of the first camera 5 and for a sensor timer for measuring an operation time of the ranging sensor 4 and starts decrementing processing of each timer (step S202).

The first processor 20 determines whether the target for performing the detection by the detection section 24 is the first camera 5 (step S204). In an initial state, the first camera 5 is set as the target for performing the detection by the detection section 24.

When the target for performing the detection by the detection section 24 is the first camera 5, the first processor 20 determines whether the value of the camera timer has become 0 (step S206), and turns off the first camera 5 when the value of the camera timer has become 0(step S208).

Thereafter, the first processor 20 switches the target for performing the detection by the detection section 24 to the ranging sensor 4 (step S210). Then, the first processor 20 determines whether the camera-using boarding-intention-determination processing is completed and the absence of a boarding intention has been determined (step S212).

When the absence of a boarding intention has been determined, the first processor 20 ends the first detection processing as is. When the absence of a boarding intention is not determined, that is, when the determination on a boarding intention using the first camera 5 is ongoing or the presence of a boarding intention has been determined, the first processor 20 determines whether both the value of the camera timer and the value of the sensor timer are 0 (step S214). When both the value of the camera timer and the value of the sensor timer are determined to be 0, the first processor 20 ends the first detection processing as is. When one or both of the value of the camera timer and the value of the sensor timer are not 0, the first processor 20 proceeds to step S204.

In step S204, when the target for performing the detection by the detection section 24 is the ranging sensor 4, the first processor 20 determines whether the value of the sensor timer has become 0 (step S216), and switches the target for performing the detection by the detection section 24 to the first camera 5 when the value of the sensor timer has become 0 (step S218). Then, the first processor 20 proceeds to step S214.

Note that the processing of steps S202 to S218 is executed by the detection section 24.

When the value of the camera timer is not 0 in step S206, the first processor 20 proceeds to step S302. In step S302, the first processor 20 acquires a frame of a photographed image taken by the first camera 5 (step S302). The detection section 24 performs the camera-using person-detection processing of determining whether the object detected in step S102 is a person, based on the acquired frame (step S304).

Then, the detection section 24 assumes that the object detected in step S102 is a person based on the acquired frame and performs the camera-using boarding-intention-determination processing of determining whether the person has a boarding intention (step S306).

The first processor 20 determines whether a person has been detected in the camera-using person-detection processing (step S308), and proceeds to step S210 when no person is detected. When a person has been detected, the first processor 20 determines whether the camera-using boarding-intention-determination processing is completed and a boarding intention has been detected (step S310).

When the camera-using boarding-intention-determination processing is completed and the boarding intention has been detected, the first processor 20 starts the image authentication ECU 30 (step S312), turns off the first camera 5 (step S314), and turns on the second camera 6 that is close to the ranging sensor 4 used for the detection of the object (step S316). Then, the first processor 20 turns on the illuminator 7 close to the second camera 6 turned on (step S318), and determines whether an authentication success/failure signal indicating the authentication result of the authentication section 34 has been received from the image authentication ECU 30 (step S320). The first processor 20 waits until receiving the authentication success/failure signal. The authentication section 34 of the started image authentication ECU 30 performs the authentication processing based on a photographed image taken by the second camera 6 and transmits the authentication success/failure signal indicating the authentication result to the vehicle authentication device 3.

When the authentication success/failure signal has been received, the first processor 20 determines whether the authentication result indicated by the authentication success/failure signal shows success (step S322). When the authentication success/failure signal indicates the authentication result as successful, the control section 27 instructs the door opening-closing device 9 to unlock the door 8 (step S324). When the authentication success signal is not received, the first detection processing ends as is.

In step S310, when the determination on a boarding intention is completed and the boarding intention is not detected or the determination on a boarding intention is not completed, the first processor 20 determines whether the determination on a boarding intention is ongoing (step S326), and proceeds to step S210 if the determination is ongoing.

In step S326, when the determination on a boarding intention is not ongoing, that is, when the determination on a boarding intention is completed, the first processor 20 turns off the first camera 5 (step S330) and proceeds to step S210.

Note that the processing of steps S302 to S312, S326, and S330 is executed by the detection section 24.

The processing of steps S322 and S324 is executed by the control section 27.

Further, in step S216, when the value of the sensor timer is not 0, the first processor 20 proceeds to step S402. In step S402, the detection section 24 performs the sensor-using person-detection processing of determining whether the object detected in step S102 is a person, based on a detection value of the ranging sensor 4 (step S402).

Then, the detection section 24 determines, based on the detection value of the ranging sensor 4, whether the moving speed of the object detected in step S102 is within a predetermined range (step S404). The predetermined range is preferably a range including the walking speed of a typical person, but is not limited thereto. When the moving speed is not within the predetermined range, the first processor 20 proceeds to step S218.

Then, when the moving speed of the object is within the predetermined range, the detection section 24 assumes that the object detected in step S102 is a person based on the detection value of the ranging sensor 4 and performs the sensor-using boarding-intention-determination processing of determining whether the person has a boarding intention (step S406).

Then, the detection section 24 determines whether the presence of a boarding intention has been determined, as a determination result of the sensor-using boarding-intention-determination processing (step S408). In step S408, the detection section 24 determines specifically, based on the detection value of the ranging sensor 4, that there is a boarding intention when the movement of the object detected in step S102 being at a halt (moving speed at 0 m/s) within a range of a preset predetermined distance from the door of the mobile body 2 continues for a predetermined period of time. Further, the detection section 24 determines that there is a boarding intention when the movement of the object detected in step S102 being limited to a predetermined range near the mobile body 2 within a range of a preset predetermined distance from the door of the mobile body 2 continues for a predetermined period of time. When the presence of a boarding intention is not determined, the first processor 20 proceeds to step S218.

When the presence of a boarding intention has been determined, the first processor 20 starts the image authentication ECU 30 (step S410), turns off the first camera 5 (step S412), and turns on the second camera 6 that is close to the ranging sensor 4 used for the detection of the object (step S414). Then, the first processor 20 turns on the illuminator 7 close to the second camera 6 turned on (step S416), and determines whether an authentication success/failure signal indicating the authentication result of the authentication section 34 has been received from the image authentication ECU 30 (step S418). The first processor 20 waits until receiving the authentication success/failure signal. The authentication section 34 of the started image authentication ECU 30 performs the authentication processing based on a photographed image taken by the second camera 6 and transmits the authentication success/failure signal indicating the authentication result to the vehicle authentication device 3.

When the authentication success/failure signal has been received, the first processor 20 determines whether the authentication result indicated by the authentication success/failure signal shows success (step S420). When the authentication success/failure signal indicates the authentication result as successful, the control section 27 instructs the door opening-closing device 9 to unlock the door 8 (step S422). When the authentication success signal is not received, the first detection processing ends as is.

Note that the processing of steps S402 to S408 is executed by the detection section 24.

The processing of steps S420 and S422 is executed by the control section 27.

In this manner, in Embodiment 1, after detecting an object approaching the mobile body 2 by the ranging sensor 4, the vehicle authentication system 1 can execute the detection of the target person P by the first camera 5 and the detection of the target person P by the ranging sensor 4.

Thus, also when the surrounding environment of the mobile body 2 is in bad conditions, the detection of the target person P by the ranging sensor 4 is performed. Therefore, the detection of the target person P and the authentication of the registered user can be performed without being affected by the surrounding environment of the mobile body 2.

Further, in Embodiment 1, after detecting an object approaching the mobile body 2 by the ranging sensor 4, the vehicle authentication system 1 can concurrently execute the detection of the target person P by the first camera 5 and the detection of the target person P by the ranging sensor 4.

Thus, also when the surrounding environment of the mobile body 2 is in bad conditions, the detection of the target person P by the first camera 5 and the detection of the target person P by the ranging sensor 4 are concurrently performed. Therefore, the detection of the target person P and the authentication of the registered user can be performed without being affected by the surrounding environment of the mobile body 2.

Furthermore, in Embodiment 1, the vehicle authentication system 1 is configured to start the image authentication ECU 30 in response to the detection of the target person P and to perform the authentication of the registered user.

Moreover, in Embodiment 1, the vehicle authentication system 1 is configured to start the image authentication ECU 30 based on earlier completion of either the detection of the target person P by the first camera 5 or the detection of the target person P by the ranging sensor 4, and to perform the authentication of the registered user.

Thus, when the surrounding environment of the mobile body 2 is not in bad conditions, the vehicle authentication system 1 performs the authentication of the registered user based on the completion of the detection of the target person P by the first camera 5 or the ranging sensor 4. Further, when the surrounding environment of the mobile body 2 is in bad conditions, the vehicle authentication system 1 performs the authentication of the registered user based on the completion of the detection of the target person P by the ranging sensor 4. Therefore, the detection of the target person P and the authentication of the registered user can be performed without being affected by the surrounding environment of the mobile body 2.

Furthermore, in Embodiment 1, the vehicle authentication system 1 is configured to determine whether the surrounding environment of the mobile body 2 is in the bright state or the dark state and to select and execute either the first detection processing or the second detection processing based on the determination result. As described above, the first detection processing is processing of concurrently executing the detection of the target person P by the first camera 5 and the detection of the target person P by the ranging sensor 4. Further, the second detection processing is processing of executing the detection of the target person P by the ranging sensor 4.

Thus, the detection of the target person P can be executed using a member corresponding to the bright/dark state of the mobile body 2.

Further, in Embodiment 1, the vehicle authentication system 1 is configured to execute the first detection processing when the surrounding environment of the mobile body 2 is in the first bright state. Furthermore, in Embodiment 1, the vehicle authentication system 1 is configured to execute the second detection processing when the surrounding environment of the mobile body 2 is in the dark state or the second bright state.

Thus, also when the surrounding environment of the mobile body 2 is in the dark state or the second bright state, the detection of the target person P and the authentication of the registered user can be performed.

Moreover, in Embodiment 1, the vehicle authentication system 1 is configured to perform the first detection processing or the second detection processing in accordance with the temperature of the vehicle authentication device 3.

Thus, the detection of the target person P using a member corresponding to the temperature of the vehicle authentication device 3 and the authentication of the registered user can be performed.

As described above, in general, as the processing load of a processor increases, the temperature of the processor increases, thereby occasionally decreasing the processing speed of the processor with the temperature increased. Therefore, the configuration is made such that the first detection processing or the second detection processing is performed in accordance with the temperature of the vehicle authentication device 3, so that the detection of the target person P using a member corresponding to the processing load of the vehicle authentication device 3 (first processor 20, in particular) and the authentication of the registered user can be performed.

Further, in Embodiment 1, the vehicle authentication system 1 is configured to perform the first detection processing when the temperature of the vehicle authentication device 3 is less than a predetermined threshold while performing the second detection processing when the temperature of the vehicle authentication device 3 is equal to or greater than the predetermined threshold.

Thus, the vehicle authentication system 1 concurrently executes the detections of the target person P by the first camera 5 and by the ranging sensor 4, when the processing load of the first processor 20, in particular, of the vehicle authentication device 3 is not high. Further, the vehicle authentication system 1 executes the detection of the target person P by the ranging sensor 4 without performing the detection of the target person P by the first camera 5 when the processing load of the first processor 20, in particular, of the vehicle authentication device 3 is high.

In general, image analyzing processing is processing with a heavy processing load. Therefore, with the configuration as described above, the detection of the target person P and the authentication of the registered user can be performed without decreasing the processing speed of the first processor 20.

Further, in Embodiment 1, the vehicle authentication system 1 is configured to perform the detection of the target person P in accordance with whether the target person P stops within a predetermined distance from the mobile body 2, based on a temporal change in the distance from the mobile body 2 to the target person P.

Thus, the boarding intention of the target person can be appropriately determined.

FIG. 7 is a flowchart showing the operation of the second detection processing in the vehicle authentication device 3. The second detection processing is processing performed by the first processor 20 of the vehicle authentication device 3.

The first processor 20 sets a predetermined value for the sensor timer for measuring an operation time of the ranging sensor 4 and starts decrementing processing of the sensor timer (step S502).

The first processor 20 determines whether the value of the sensor timer has become 0 (step S504), and when the value of the sensor timer has become 0, ends the second detection processing as is.

When the value of the sensor timer is not 0, the detection section 24 performs the sensor-using person-detection processing of determining whether the object detected in step S102 is a person, based on a detection value of the ranging sensor 4 (step S506).

Then, the detection section 24 determines, based on the detection value of the ranging sensor 4, whether the moving speed of the object detected in step S102 is within a predetermined range (step S508). The predetermined range is preferably a range including the walking speed of a typical person, but is not limited thereto. When the moving speed is not within the predetermined range, the first processor 20 proceeds to step S504.

Then, when the moving speed of the object is within the predetermined range, the detection section 24 assumes that the object detected in step S102 is a person based on the detection value of the ranging sensor 4 and performs the sensor-using boarding-intention-determination processing of determining whether the person has a boarding intention (step S510).

Then, the detection section 24 determines whether the presence of a boarding intention has been determined, as a determination result of the sensor-using boarding-intention-determination processing (step S512). In step S512, the detection section 24 determines specifically, based on the detection value of the ranging sensor 4, that there is a boarding intention when the movement of the object detected in step S102 being at a halt (moving speed at 0 m/s) within a range of a preset predetermined distance from the door of the mobile body 2 continues for a predetermined period of time. Further, the detection section 24 determines that there is a boarding intention when the movement of the object detected in step S102 being limited to a predetermined range near the mobile body 2 within a range of a preset predetermined distance from the door of the mobile body 2 continues for a predetermined period of time. When the presence of a boarding intention is not determined, the first processor 20 proceeds to step S504.

When the presence of a boarding intention has been determined, the first processor 20 starts the image authentication ECU 30 (step S514), turns off the first camera 5 (step S516), and turns on the second camera 6 that is close to the ranging sensor 4 used for the detection of the object (step S518). Then, the first processor 20 turns on the illuminator 7 close to the second camera 6 turned on (step S520), and determines whether an authentication success/failure signal indicating the authentication result of the authentication section 34 has been received from the image authentication ECU 30 (step S522). The first processor 20 waits until receiving the authentication success/failure signal. The authentication section 34 of the started image authentication ECU 30 performs the authentication processing based on a photographed image taken by the second camera 6 and transmits the authentication success/failure signal indicating the authentication result to the vehicle authentication device 3.

When the authentication success/failure signal has been received, the first processor 20 determines whether the authentication result indicated by the authentication success/failure signal shows success (step S524). When the authentication success/failure signal indicates the authentication result as successful, the control section 27 instructs the door opening-closing device 9 to unlock the door 8 (step S526). When the authentication success signal is not received, the first detection processing ends as is.

Note that the processing of steps S502 to S512 is executed by the detection section 24.

The processing of steps S524 and S526 is executed by the control section 27.

In Embodiment 1, after detecting an object by the ranging sensor 4 provided in the mobile body 2, the detection section 24 can concurrently execute the detection of the target person P by the first camera 5 provided in the mobile body 2 and the detection of the target person P by the ranging sensor 4, but is not limited thereto. For example, the detection section 24 performs the detection of the target person P by the first camera 5 provided in the mobile body 2 after detecting an object by the ranging sensor 4 provided in the mobile body 2, and when the detection of the target person P fails, may execute the detection of the target person P by the ranging sensor 4.

### 2. Embodiment 2

Next, Embodiment 2 will be described. Note that hereinafter, only the points that differ from the aforementioned embodiment will be described and the description of the same points as those of the aforementioned embodiment will be omitted.

### [2-1. Configuration of Vehicle Authentication System]

The detection section 24 in Embodiment 2 performs the detection of the target person P by the first camera 5 when the first bright state is determined by the brightness-darkness determination section 25 and executes the detection of the target person P by the ranging sensor 4 when the target person P cannot be detected by the first camera 5.

### [2-2. Operation of Vehicle Authentication Device]

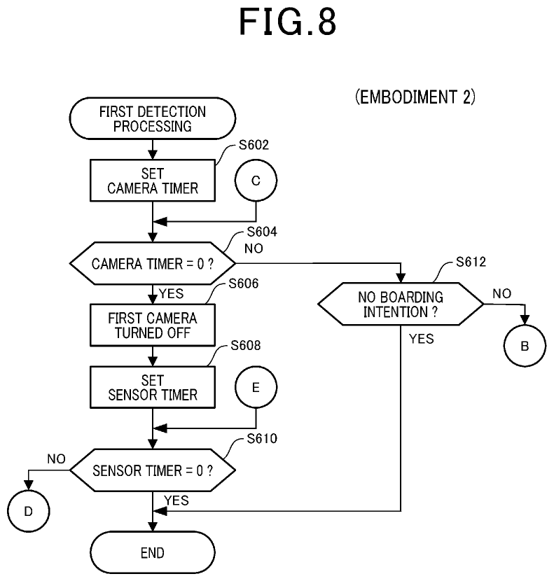

FIG. 8 is a flowchart showing the operation of the first detection processing in the vehicle authentication device 3 in Embodiment 2. The first detection processing is processing performed by the first processor 20 of the vehicle authentication device 3.

The first processor 20 sets a predetermined value for the camera timer for measuring an operation time of the first camera 5 and starts decrementing processing of the camera timer (step S602).

Then, the first processor 20 determines whether the value of the camera timer has become 0 (step S604), and when the value of the camera timer has become 0, turns off the first camera 5 (step S606).

The first processor 20 sets a predetermined value for the sensor timer for measuring an operation time of the ranging sensor 4 and starts decrementing processing of the sensor timer (step S608). Then, the first processor 20 determines whether the value of the sensor timer has become 0 (step S610), and when the value of the sensor timer has become 0, ends the first detection processing.

In step S604, when the value of the camera timer is not 0, the first processor 20 determines whether the camera-using boarding-intention-determination processing is completed and the absence of a boarding intention has been determined (step S612).

When the absence of a boarding intention has been determined, the first processor 20 ends the first detection processing as is. When the absence of a boarding intention is not determined, that is, when the determination on a boarding intention using the first camera 5 is ongoing or the presence of a boarding intention has been determined, the first processor 20 proceeds to step S302. Note that in Embodiment 2, when a person is not detected in step S308, the determination on a boarding intention is ongoing in step S326, or after step S330, the first processor 20 proceeds to step S604.

In step S605, when the value of the sensor timer is not 0, the first processor 20 proceeds to step S402. Note that in Embodiment 2, when the moving speed of the object is not within a predetermined range in step S404 or the presence of a boarding intention is not determined in step S408, the first processor 20 proceeds to step S610.

Note that the processing of steps S602 to S612 is executed by the detection section 24.

In this manner, in Embodiment 2, the vehicle authentication system 1 is configured to execute the detection of the target person P by the ranging sensor 4 when the surrounding environment of the mobile body 2 is in the first bright state and the detection of the target person P cannot be performed by the first camera 5.

Thus, the detection of the target person P and the authentication of the registered user can be performed without being affected by the surrounding environment.

Note that in any surrounding environment of the mobile body 2, with the configuration in which the detection of the target person P by the ranging sensor 4 is executed when the detection of the target person P by the first camera 5 cannot be performed, the same advantageous effects can also be obtained. In that case, the detection of the surrounding environment may not be performed.

### 3. Configurations Supported by Aforementioned Embodiments

The aforementioned embodiments support the following configurations.
(Configuration 1) A vehicle authentication system including: a detection section that detects an object approaching a mobile body and, after detecting the object, detects a target person approaching the mobile body; and an authentication section that performs authentication of the target person as a registered user, in which after detecting the object by an object detection sensor provided in the mobile body, the detection section is capable of executing detection of the target person by a camera provided in the mobile body and detection of the target person by the object detection sensor

According to the vehicle authentication system of Configuration 1, the authentication of a registered user is enabled without being affected by the surrounding environment.
(Configuration 2) The vehicle authentication system according to Configuration 1, in which after detecting the object by the object detection sensor provided in the mobile body, the detection section is capable of concurrently executing the detection of the target person by the camera provided in the mobile body and the detection of the target person by the object detection sensor.

According to the vehicle authentication system of Configuration 2, the same operational effects as those of the vehicle authentication system of Configuration 1 are produced.
(Configuration 3) The vehicle authentication system according to Configuration 2, in which the authentication section starts the authentication in response to detection of the target person by the detection section.

According to the vehicle authentication system of Configuration 3, the same operational effects as those of the vehicle authentication system of Configuration 1 is produced.
(Configuration 4) The vehicle authentication system according to Configuration 3, in which the authentication section starts the authentication based on completion of the detection of the target person by one of the camera and the object detection sensor that is earlier than the detection of the target person by another of the camera and the object detection sensor.

According to the vehicle authentication system of Configuration 4, the same operational effects as those of the vehicle authentication system of Configuration 1 are produced.
(Configuration 5) The vehicle authentication system according to Configuration 1, further including a brightness-darkness determination section that determines whether a surrounding environment of the camera is in a bright state or a dark state, after detecting the object by the object detection sensor, in which the detection section selects and executes one or both of the detection of the target person by the camera and the detection of the target person by the object detection sensor, based on a determination result of the brightness-darkness determination section.

According to the vehicle authentication system of Configuration 5, the detection of a target person can be executed using a member corresponding to the bright/dark state of the mobile body.
(Configuration 6) The vehicle authentication system according to Configuration 5, in which when the bright state is determined by the brightness-darkness determination section, the detection section is capable of concurrently executing the detection of the target person by the camera and the detection of the target person by the object detection sensor.

According to the vehicle authentication system of Configuration 6, the detection of a target person can be executed using a member corresponding to the bright/dark state of the mobile body.
(Configuration 7) The vehicle authentication system according to Configuration 5, in which the brightness-darkness determination section determines the dark state when illuminance of a photographed image taken by the camera is less than a first threshold, determines a first bright state when the illuminance is equal to or greater than the first threshold and less than a second threshold, and determines a second bright state when the illuminance is equal to or greater than the second threshold, and the detection section executes the detection of the target person by the object detection sensor when the dark state or the second bright state is determined by the brightness-darkness determination section.

According to the vehicle authentication system of Configuration 7, also when the surrounding environment of the mobile body is in the dark state or the second bright state, the detection of a target person can be executed.
(Configuration 8) The vehicle authentication system according to Configuration 5, in which the detection section: detects the target person by the camera when the bright state is determined by the brightness-darkness determination section, and executes the detection of the target person by the object detection sensor when the target person cannot be detected by the camera.

According to the vehicle authentication system of Configuration 8, the same operational effects as those of the vehicle authentication system of Configuration 1 are produced.
(Configuration 9) The vehicle authentication system according to Configuration 1, further including a temperature detection section that detects a temperature of a member having a function of the detection section, in which after detecting the object by the object detection sensor, the detection section selects and executes one or both of the detection of the target person by the camera and the detection of the target person by the object detection sensor, based on the temperature detected by the temperature detection section.

According to the vehicle authentication system of Configuration 9, the detection of a target person using a member corresponding to the temperature of the vehicle authentication device and the authentication of a registered user can be performed.
(Configuration 10) The vehicle authentication system according to Configuration 9, in which the detection section concurrently executes the detection of the target person by the camera and the detection of the target person by the object detection sensor when the temperature detected by the temperature detection section is less than a predetermined value.

According to the vehicle authentication system of Configuration 10, the same operational effects as those of the vehicle authentication system of Configuration 9 are produced.
(Configuration 11) The vehicle authentication system according to Configuration 9, in which the detection section selects and executes the detection of the target person by the object detection sensor when the temperature detected by the temperature detection section is equal to or greater than a predetermined value.

According to the vehicle authentication system of Configuration 11, the detection of a target person and the authentication of a registered user can be performed without decreasing the processing speed of a member having the function of the detection section.
(Configuration 12) The vehicle authentication system according to Configuration 1, in which the detection section detects the target person in accordance with whether the target person stops within a predetermined distance from the mobile body, based on a temporal change in a distance from the mobile body to the target person, the distance being acquired from the object detection sensor.

According to the vehicle authentication system of Configuration 12, a boarding intention of a target person can be appropriately determined.
(Configuration 13) The vehicle authentication system according to Configuration 1, in which the detection section executes the detection of the target person by the object detection sensor when the target person cannot be detected by the camera.

According to the vehicle authentication system of Configuration 13, the same operational effects as those of the vehicle authentication system of Configuration 1 are produced.

### REFERENCE SIGNS LIST

1 vehicle authentication system
2 mobile body
3 vehicle authentication device
4 ranging sensor
4a right ranging sensor
4b left ranging sensor
4c rear ranging sensor
5 first camera
5a first right camera
5b first left camera
5c first rear camera
6 second camera
6a second right camera
6b second left camera
6c second rear camera
7 illuminator
7a right illuminator
7b left illuminator
7c rear illuminator
8 door
8a driver's door
8b rear right door
8c passenger's door
8d rear left door
8e rear gate
9 door opening-closing device
9a front right side door opening-closing device
9b rear right side door opening-closing device
9c front left side door opening-closing device
9d rear left side door opening-closing device
9e rear gate opening-closing device
10 communication device
11 electronic key
20 first processor
21 first memory
22 first program
23 authentication data
24 detection section
25 brightness-darkness determination section
26 temperature detection section
27 control section
30 image authentication ECU
31 second processor
32 second memory
33 second program
34 authentication section
40 temperature sensor
P target person

1. A vehicle authentication system comprising:
a detection section that detects an object approaching a mobile body and, after detecting the object, detects a target person approaching the mobile body; and
an authentication section that performs authentication of the target person as a registered user,
wherein after detecting the object by an object detection sensor provided in the mobile body, the detection section is capable of executing detection of the target person by a camera provided in the mobile body and detection of the target person by the object detection sensor.

2. The vehicle authentication system according to claim 1, wherein after detecting the object by the object detection sensor provided in the mobile body, the detection section is capable of concurrently executing the detection of the target person by the camera provided in the mobile body and the detection of the target person by the object detection sensor.

3. The vehicle authentication system according to claim 2, wherein the authentication section starts the authentication in response to detection of the target person by the detection section.

4. The vehicle authentication system according to claim 3, wherein the authentication section starts the authentication based on completion of the detection of the target person by one of the camera and the object detection sensor that is earlier than the detection of the target person by another of the camera and the object detection sensor.

5. The vehicle authentication system according to claim 1, further comprising a brightness-darkness determination section that determines whether a surrounding environment of the camera is in a bright state or a dark state, after detecting the object by the object detection sensor,
wherein the detection section selects and executes one or both of the detection of the target person by the camera and the detection of the target person by the object detection sensor, based on a determination result of the brightness-darkness determination section.

6. The vehicle authentication system according to claim 5, wherein when the bright state is determined by the brightness-darkness determination section, the detection section is capable of concurrently executing the detection of the target person by the camera and the detection of the target person by the object detection sensor.

7. The vehicle authentication system according to claim 5,
wherein
the brightness-darkness determination section determines the dark state when illuminance of a photographed image taken by the camera is less than a first threshold, determines a first bright state when the illuminance is equal to or greater than the first threshold and less than a second threshold, and determines a second bright state when the illuminance is equal to or greater than the second threshold, and
the detection section executes the detection of the target person by the object detection sensor when the dark state or the second bright state is determined by the brightness-darkness determination section.

8. The vehicle authentication system according to claim 5, wherein
the detection section:
detects the target person by the camera when the bright state is determined by the brightness-darkness determination section, and
executes the detection of the target person by the object detection sensor when the target person cannot be detected by the camera.

9. The vehicle authentication system according to claim 1, further comprising a temperature detection section that detects a temperature of a member having a function of the detection section,
wherein after detecting the object by the object detection sensor, the detection section selects and executes one or both of the detection of the target person by the camera and the detection of the target person by the object detection sensor, based on the temperature detected by the temperature detection section.

10. The vehicle authentication system according to claim 9, wherein the detection section concurrently executes the detection of the target person by the camera and the detection of the target person by the object detection sensor when the temperature detected by the temperature detection section is less than a predetermined value.

11. The vehicle authentication system according to claim 9, wherein the detection section selects and executes the detection of the target person by the object detection sensor when the temperature detected by the temperature detection section is equal to or greater than a predetermined value.

12. The vehicle authentication system according to claim 1, wherein the detection section detects the target person in accordance with whether the target person stops within a predetermined distance from the mobile body, based on a temporal change in a distance from the mobile body to the target person, the distance being acquired from the object detection sensor.

13. The vehicle authentication system according to claim 1, wherein the detection section executes the detection of the target person by the object detection sensor when the target person cannot be detected by the camera.
